(19) United States
(12) Patent Application Publication
(10) Pub. No.: US 2005/0217706 A1
(43) Pub. Date: Oct. 6, 2005

(54) Fluid assisted cryogenic cleaning

(76) Inventors: Souvik Banerjee, Fremont, CA (US); Harlan Forrest Chung, Castro Valley, CA (US)

Correspondence Address: BOC, INC., 575 MOUNTAIN AVE, MURRAY HILLS, NJ, 07974-2064, US

(21) Appl. No.: 10/509,955

(22) PCT Filed: Apr. 3, 2003
(86) PCT No.: PCT/US03/10354

§ 371 Date: Jun. 2, 2005

Related U.S. Application Data
(60) Provisional application No. 60/369,852, filed on Apr. 5, 2002.
(60) Provisional application No. 60/369,853, filed on Apr. 5, 2002.

(51) Int. Cl. B08B 3/12

(52) U.S. Cl. 134/26; 134/1; 134/1.1

(57) ABSTRACT

The present invention is directed to fluid assisted cryogenic cleaning of a substrate surface requiring precision cleaning such as semiconductors, metals, and dielectric films. The process comprises the steps of applying a fluid selected from the group consisting of high vapor pressure liquids, reactive gases, and vapors of reactive liquids onto the substrate surface followed by or simultaneously with cryogenic cleaning of the substrate surface to remove contaminants.

### FIELD OF THE INVENTION

This invention relates to the use of a liquid or vapor cleaning process carried out either simultaneously with or prior to cryogenic cleaning to aid in the removal of foreign materials and contaminants from semiconductor surfaces and other surfaces involved in precision cleaning.

### BACKGROUND OF THE INVENTION

Cleaning or surface preparation of silicon wafers with or without various layers of films is critical in integrated circuit manufacturing processes. The removal of particles and contaminants from wafer surfaces is performed at several critical process steps during the fabrication of integrated circuits. At a 0.18 μm technology node, 80 out of 400 steps or 20% of the fabrication sequence is dedicated to cleaning. The challenges of cleaning technology are multiplied by the varied types of films, topographies, and contaminants to be removed in front-end-of-line (FEOL) and back-end-of-line (BEOL) cleaning processes. Removal of particles is an important part of this cleaning.

For the defect-free manufacture of integrated circuits, the International Technology Roadmap for Semiconductors (ITRS) indicates that the critical particle size is half of a DRAM ½ pitch [1]. Thus, at the 130 nm technology node, the DRAM ½ pitch being 130 nm, the critical particle size is 65 nm. Therefore, particles larger than 65 nm size must be removed to ensure a defect-free device.

Such small particles are difficult to remove since the ratio of the force of adhesion to removal increases for smaller-sized particles. For submicron particles, the primary force of adhesion of the particles to a surface is the Van der Waals force. This force depends on the size of the particle, the distance of the particle to the substrate surface, and the Hamaker constant. The Van der Waals force for a spherical particulate on a flat substrate is given as in equation 1:

$${F}_{ad} = \frac{{A}_{132} {d}_{p}}{12 {Z}_{0}^{2}} \qquad ( 1 )$$

where A₁₃₂ is the Hamaker constant of the system composed of the particle, the surface and the intervening medium; dₚ is the particle diameter; and Z₀ is the distance of the particle from the surface. The Hamaker constant A₁₃₂ for the composite system is given as in equation (2):
A₁₃₂=A₁₂+A₃₃−A₁₃−A₂₃ (2)

The relationship of the Hamaker constant of two dissimilar materials is expressed as the geometric mean of the individual Hamaker constants as Aᵢⱼ=(Aᵢᵢ*Aⱼⱼ)^{1/2} where Aᵢᵢ and Aⱼⱼ are the Hamaker constants of materials i and j. It is calculated theoretically using either the Lifshitz or the London models. The Hamaker constant for particles and surfaces used in integrated circuit manufacturing processes is given in literature [2, 3] and is less when the intervening medium is liquid as compared to air. The Van der Waals force, being directly proportional to the Hamaker constant, is therefore reduced when there is a liquid layer between the particle and the surface.

In addition to the difficulty in removing small particles from the surface, there are various types of organic and metal-organic contaminants which must be removed. The demands for greater switching speed and circuit performance have seen the advent of new dielectric materials (dielectric constant of <3) and metals to reduce the RC delay constant in circuits. The metal of choice, which is copper, has added several challenges to the process integration scheme. For aluminum interconnects, the metal patterning was performed by reactive ion etching (RIE) of the aluminum followed by dielectric deposition. With copper, the dielectric film is first deposited and etched to form vias and trenches followed by the deposition of copper in those etched features. The excess copper is then removed using chemical mechanical polishing (CMP) to planarize the surface for subsequent layers of film. This method of forming copper interconnects for the back-end-of-line (BEOL) is known as the Dual Damascene process.

Following the dielectric etch to form the vias and trenches, a large amount of fluoropolymeric residue is left both on the surface of the wafer and on the inside of features as seen in FIG. 1. These residues are generated during the etching process, partly for sidewall passivation during anisotropic etching. The etch residue has to be cleaned prior to the deposition of the successive film layers: the copper barrier Ta/TaN film, copper seed layer, and finally the electrochemical filling of the features with copper in the Damascene process.

The dimensions of the features used in the interconnects at the BEOL are currently around 0.13 μm. For cryogenic cleaning to work effectively in removing the sidewall residues from inside the features, as shown in FIG. 1, the cryogenic particles must be less than 0.13 μm in size. As well, these particles must arrive at the surface of the wafer with enough velocity to impart the momentum transfer required to dislodge the sidewall residue.

There are three mechanisms by which surface cleaning is done: 1) momentum transfer by cryogenic particles to overcome the force of adhesion of slurry particles to the wafer surface, 2) drag force of the cleaning gases to remove the dislodged particles off the surface of the wafer, and 3) the dissolution of organic contaminants by liquid formed at the interface of the cryogenic particle and the wafer surface.

In CO₂ cryogenic cleaning, the gas flow over the wafer surface creates a boundary layer. The CO₂ cryogenic particles must travel through the boundary layer to arrive at the wafer surface and at the contaminant particle to be removed. During the flight through the boundary layer, their velocity decreases due to the drag force on them by the gaseous CO₂ in the boundary layer. Assuming the thickness of the boundary layer to be h, a snow particle must enter the layer with a normal component of velocity equal to at least h/t where t is the time taken to cross the boundary layer and arrive at the wafer surface. The relaxation time of the particle crossing the boundary layer is given in equation (1) as the following:

$$τ = \frac{2 {a}^{2} {ρ}_{p} {C}_{c}}{9 η} \qquad ( 1 )$$

where:
a is the particle radius
ρₚ is the particle density
η is the viscosity of the gas
C_{c} is the Cunningham slip correction factor given as in equation (2)
   C_{c}=1+1.246(λ/a)+0.42(λ/a)exp[−0.87(a/λ)] (2)
   where λ is the mean free path of gas molecules. Since the CO₂ cryogenic cleaning is conducted at atmospheric pressure, the Cunningham slip correction factor becomes equal to 1 in equation (1) for cryogenic particles larger than 0.1 μm in size.

Thus, for CO₂ snow particles to have sufficient momentum to remove foreign material from the wafer surface and from inside the features, the time to cross the boundary layer must be less than the relaxation time, in which case they will arrive at the surface with greater than 36% of the initial velocity. Equation 1 shows that the relaxation time decreases with particle size. Therefore, the smaller-sized particles will not be able to arrive at the wafer surface with sufficient velocity to effectively clean the inside walls of the submicron vias and trenches.

The prior art processes generally use CO₂ or argon cryogenic spray for removing foreign material from surfaces. As examples, see U.S. Pat. No. 5,931,721 entitled Aerosol Surface Processing; U.S. Pat. No. 6,036,581 entitled Substrate Cleaning Method and Apparatus: U.S. Pat. No. 5,853,962 entitled Photoresist and Redeposition Removal Using Carbon Dioxide Jet Spray; U.S. Pat. No. 6,203,406 entitled Aerosol Surface Processing; and U.S. Pat. No. 5,775,127 entitled High Dispersion Carbon Dioxide Snow Apparatus. In all of the above prior art patents, the foreign material is removed from a relatively planar surface by physical force involving momentum transfer to the contaminants. Since the force of adhesion between the contaminant particles and the substrate is strong, the prior art processes are ineffective for removing small, <0.3 μm particles. As well, such cleaning methods are inadequate for features with high aspect ratios such as in vias and trenches in the back-end-of-line integrated device fabrication process where removal of small submicron particles and complex polymeric residues, as generated by dielectric etch processes, is required.

U.S. Pat. No. 6,332,470 entitled Aerosol Substrate Cleaner discloses the use of vapor only or vapor in conjunction with high pressure liquid droplets for cleaning semiconductor substrate. Unfortunately, the liquid impact does not have sufficient momentum transfer capability as solid CO₂ and will therefore not be as effective in removing the smaller-sized particles. U.S. Pat. No. 5,908,510 entitled Residue Removal by Supercritical Fluids discloses the use of cryogenic aerosol in conjunction with supercritical fluid or liquid CO₂. Since CO₂ is a non-polar molecule, the solvation capability of polar foreign material is significantly reduced. Also, since the liquid or supercritical CO₂ formation requires high pressure (greater than 75 psi for liquid and 1080 psi for supercritical), the equipment is expensive. U.S. Pat. No. 6,231,775 proposes the use of sulfur trioxide gas by itself or in combination with other gases for removing organic materials from substrates as in ashing. Such vapor phase cleaning is inadequate for removing cross-linked photoresist formed during the etching in a typical dual Damascene integration scheme using low k materials such as carbon doped oxides.

As such, there remains a need for the effective and efficient removal of contaminants including particles, foreign materials, and chemical residues as well as homogeneous and inhomogeneous contaminants consisting of cross-linked and bulk photoresist, post-etch residues, and sub-micron sized particulates both from the surface of the semiconductor wafers, metal films, and other substrates requiring precision cleaning as well as from inside high aspect ratio features.

### SUMMARY OF THE INVENTION

The present invention provides for a new and improved process for the cleaning of substrate surfaces requiring precision cleaning such as semiconductors, metals, and dielectric films.

The invention comprises a cleaning process to remove contaminants from substrate surfaces requiring precision cleaning. It is used either prior to or simultaneously with cryogenic cleaning to remove foreign matter and contaminants from the substrate surface. The process applies a fluid selected from a high-vapor pressure liquid, a reactive gas, or vapor of a reactive liquid, depending on the contaminants to be removed from the substrate surface. The fluid preferably stays in contact with the surface for up to 20 minutes. It forms an environment which removes contaminants from the surface or reduces the force of adhesion to the surface so that they can be subsequently removed using cryogenic cleaning.

### BRIEF DESCRIPTION OF THE DRAWINGS

Embodiments of the present invention are described with reference to the figures in which:

FIG. 1 shows the cleaning of the post-trench etch residues in a dual-damascene structure. The left image is the SEM of the post-trench etch structure with etch residues present The right image is the SEM of the post-trench etch structure after a sequence of plasma and wet clean steps.

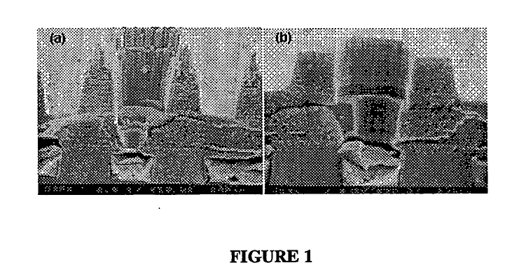

FIG. 2 is a graph showing the efficiency of particle removal compared to particle size for both standard cryogenic cleaning and the present liquid-assisted cleaning process.

FIG. 3 shows a schematic diagram of a conventional CO₂ cryogenic cleaning system.

### DETAILED DESCRIPTION

Liquid-Assisted Cleaning Process and Example

Liquids used in the present process are high vapor pressure liquids which reduce the Van der Waals force between foreign material and a substrate surface such as a semiconductor wafer surface or film surface. The high vapor pressure liquid is sprayed on to the surface of the substrate. The initial spraying of liquid will reduce the Van der Waals forces thereby allowing the subsequent cryogenic cleaning to more easily remove foreign material from the substrate surface. If the upstream process prior to the cryogenic cleaning is an aqueous based process, as in co-pending U.S. patent application Ser. No. 10/215,859, then the liquid may also remove the bulk water prior to the cryogenic cleaning. Further, the high vapor pressure liquid may act to dissolve organic contaminants from the surface. A particular high-vapor pressure liquid will be chosen depending on the organic contaminants contained on the substrate surface. A skilled person in this field will be aware of the types of liquids which would dissolve common organic contaminants.

The high vapor pressure liquids suitable for use in the present invention include, but are not limited to, ethanol, acetone, ethanol-acetone mixtures, isopropyl alcohol, methanol, methyl formate, methyl iodide, ethyl bromide, acetonitrile, ethyl chloride, pyrrolidine, and tetrahydrofuran. However, any liquid having a high vapor pressure may be used. High vapor pressure liquids will readily evaporate off the surface of the substrate without the need for drying by heating or spinning the substrate. The liquids also preferably have low freezing points and are polar in nature. The low freezing point of the liquids ensure that any residual liquid left on the wafer surface at the time of cryogenic cleaning will not freeze due to the drop in wafer temperature that can be attained during the cryogenic cleaning process. The polarity of the liquid aids in the dissolution of organic and inorganic contaminants on the wafer surface. Preferably, the vapor pressure of the liquid is greater than 5 kPa at 25° C., the freezing point of the liquid is below −50° C., and the dipole moment is greater than 1.5 D.

High vapor pressure liquids may be used on any substrate surface requiring precision cleaning however, preferred surfaces include semiconductor surfaces as well as metal and dielectric films. Therefore, whenever the term “semiconductor”, “metal film”, “dielectric film”, or “wafer” is used herein, it is intended that the same process may be applied to other substrate surfaces. Other surfaces include hard disk media, optics, GaAs substrates and films in compound semiconductor manufacturing processes. Examples provided herein are not meant to limit the present invention.

In one embodiment of the present invention, the high-vapor pressure liquid is sprayed onto the surface of a semiconductor wafer at a temperature of 30°-50° C. The liquid may be sprayed either as a thick film or as a thin layer. The layer is preferably at least 5-10 Δ thick. It is preferably sprayed using a misting nozzle made of Teflon used in wet benches for spraying deionized water onto wafer surfaces. However, any other nozzle used in the art may be employed. The wafer is preferably covered with the liquid for at least one minute and preferably up to 10 minutes. The liquid may be applied to the surface once during this time period or it may be sprayed multiple times to ensure that the wafer surface remains wet. As well, the wafer may be rotated at approximately 100 rpm while the liquid is sprayed on it to ensure uniform coverage of the wafer surface.

Following this wetting period, the cryogenic spraying is initiated. Cryogenic spraying processes may use carbon dioxide, argon or other gases and are well known within the art. Any known technique may be used and an example of CO₂ cryogenic cleaning is described below. The result of the initial application of high vapor pressure liquid is the reduction of the Hamaker constant and hence the Van der Waals forces. This application lowers the forces of adhesion of the contaminants to the wafer surface and the contaminants is easier to remove from the wafer surface than through the use of cryogenic cleaning alone.

Alternatively, the liquid can be applied simultaneously with the cryogenic cleaning. In such a case, for example, a second nozzle for spraying the liquid would be mounted in conjunction with a first nozzle used for CO₂ cryogenic cleaning. The liquid would preferably be applied in a thin layer and the CO₂ cryogenic cleaning would continue simultaneously with the spraying of the liquid onto the substrate.

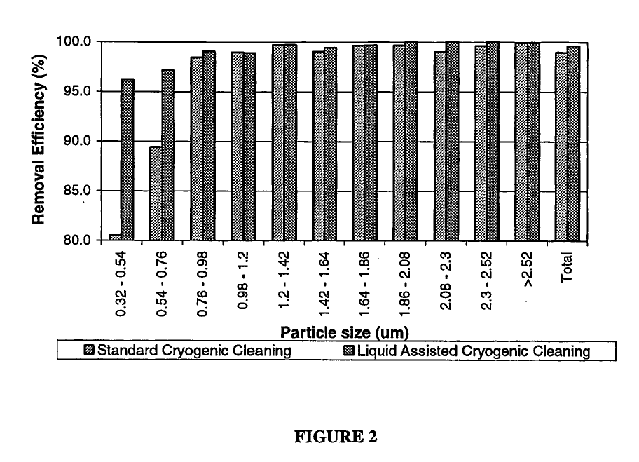

As a result of the use of the high vapor pressure liquid, the removal of particle contaminants by cryogenic cleaning is significantly improved. FIG. 2 shows the efficiency of particle removal compared to particle size for both standard cryogenic cleaning as well as liquid-assisted cryogenic cleaning. Removal of particles having a size below 0.76 μm is significantly improved with the use of the present liquid-assisted CO₂ cryogenic cleaning process rather than standard CO₂ cryogenic cleaning. For particle sizes ranging from 0.98 μm to 2.50 μm, there was no significant difference in the removal of particles between the use of the present liquid assisted cryogenic cleaning and the standard CO₂ cryogenic cleaning process.

Vapor-Assisted Cleaning and Example

A reactive gas or reactive vapor of a liquid may be used to aid in the removal of contaminants. The reactive gas or vapor is selected according to its reactivity with the contaminants on the substrate surface. Reactive gases or vapors are generally used to remove organic photoresist and fluoropolymer etch residue inside features on the substrate surface. After reacting with the contaminants, the gas/vapor preferably produces byproducts in a gaseous form. (Hereinafter, for ease of reference in the description of the present invention, references to reactive gas may include reactive vapors of a liquid and references to reactive vapors may include reactive gases.)

In semiconductor wafer cleaning processes, the contaminants to be removed include not only particle contaminants but also films of organic, inorganic, and metal-organic residues at various steps in microelectronic manufacturing both in FEOL (front-end-of-line) and BEOL processes. These films cannot be removed by purely physical mechanisms. Chemical assistance to any physical mechanism of removal is required to meet cleanliness requirements. In the present invention, the gas phase cleaning is the chemical means of cleaning whereas the cryogenic cleaning is predominantly the physical mechanism of cleaning. The two processes working in tandem or in sequence are able to completely remove the homogeneous or inhomogeneous contaminants.

Examples of the reactive vapor which may be used in the present process may be the vapor of a high vapor pressure liquid and include, but are not limited to, acetone, ethanol-acetone mixtures, isopropyl alcohol, methanol, methyl formate, methyl iodide, and ethyl bromide. It may also include a gas such as ozone, water vapor, hydrogen, nitrogen, nitrogen oxides, nitrogen trifluoride, helium, argon, neon, sulfur trioxide, oxygen, fluorine, or fluorocarbon gases or combinations of gases. The gas or vapor should be reactive with the organic photoresist as well as the fluoropolymer etch residue inside the features. As well, the reaction byproducts are preferably gaseous so that they can be removed from the cleaning chamber by the flow of nitrogen gas. Preferred gases and vapors of liquids include isopropyl alcohol, ethanol-acetone mixtures, methanol, ozone, water vapor, nitrogen trifluoride, sulfur trioxide, oxygen, fluorine and fluorocarbon gases.

In post-etch cleaning applications, cryogenic particles cannot get inside the high aspect ratio features of vias and trenches. Gas or vapor is needed to diffuse into these features effectively. The gas or vapor will then chemically react with the polymeric residue and convert it to gaseous by-products which can be removed from the surface by a flow of nitrogen across the substrate surface. Alternatively, it can be introduced in a separate chamber kept under low pressure. The gas/vapor phase reaction in this chamber could be done at temperatures of up to 200 EC. Following this cleaning process, the wafers may be transferred to a second cleaning chamber at atmospheric pressure where the cryogenic cleaning takes place.

During the process, the vapor may condense on the wafer surface. With the proper choice of vapors, the condensation could also lower the Hammaker constant and hence the force of adhesion of particles to surfaces. This condensation would thereby help in the particle removal by cryogenic cleaning.

The gas or vapor can be further made to increase in the reactivity with the contaminants to be removed by using a free radical initiator such as ultra violet light, X-ray, Excimer laser, corona discharge or plasma to generate reactive chemical species. It is combined with the physical cleaning of snow or cryogenic aerosols to remove the non-reactive contaminants. Similar cleaning mechanisms are seen in wet cleaning and dual frequency plasma cleaning using downstream MW plasma to generate the chemical species for reaction with the contaminant and RF plasma to generate the ion bombardment.

In one embodiment of the present invention in combination with CO₂ cryogenic cleaning, the vapor of a liquid is sprayed through a nozzle attached to the same arm as a CO₂ cryogenic nozzle. The nozzle may be a small stainless steel bore, ¼ to ½″ in diameter, or a specially designed nozzle with corona wire along the axis to initiate discharges in the vapor. The nozzle is preferably at an angle of approximately 10°-90° to the substrate surface. The vapor may also be sprayed through a showerhead positioned above the substrate surface to ensure uniform coverage of the substrate surface. During the vapor delivery, the substrate is preferably kept at the same temperature as the vapor. If condensation of the vapor is desired, the substrate may be kept at a temperature below the vapor to initiate condensation of the vapor into a thin film of liquid on the substrate surface. However, if the vapor is not sufficiently reactive for a given contaminant type, the vapor may be made reactive with the assistance of a free radical initiator. The vapor is sprayed onto the substrate surface for preferably up to twenty minutes. It may be sprayed continuously or intermittently. Preferably, a single type of vapor is used but a mixture of vapors may be used simultaneously or sequentially, if preferred, to remove contaminants.

The spraying of the reactive gas or vapor in accordance with the present invention may occur in the same chamber as the cryogenic cleaning or it may be done in a separate chamber. As well, the cryogenic cleaning may be initiated simultaneously with or directly after the reactive gas or vapor is used. Depending on the reactive gas or vapor used, for example water vapor, it may be desirable to purge the chamber of this vapor prior to initiating the cryogenic cleaning.

As a result of the use of the reactive gas or vapor, the removal of contaminants, particularly from etched features on a substrate surface, is significantly improved. This cleaning method is particularly beneficial in removing homogeneous contaminants such as a film of post etch residue on the sidewalls of vias and trenches or the photoresist remaining after etching.

### EXAMPLE

### Standard CO₂ Cryogenic Cleaning

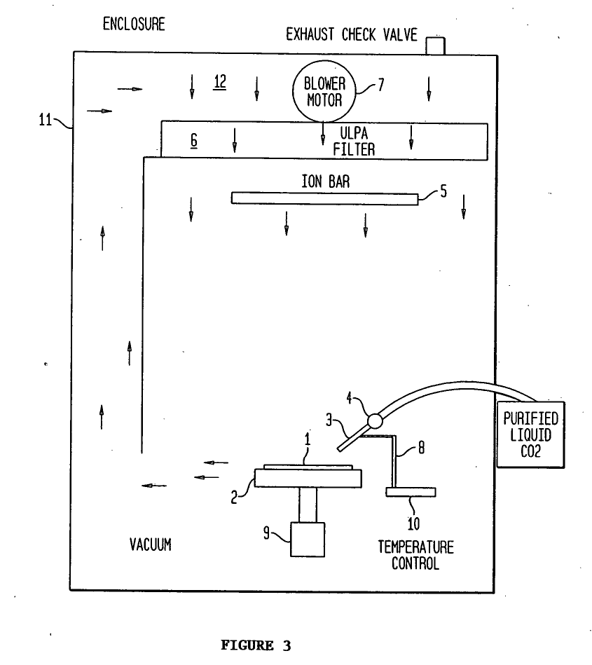

Either following the fluid cleaning process or simultaneously with it, standard cryogenic cleaning is carried out. A standard CO₂ cryogenic cleaning process is described in U.S. Pat. No. 5,853,962 which is incorporated herein by reference. As an example of a typical CO₂ cryogenic cleaning system, reference is made to FIG. 3. The cleaning container 12 provides an ultra clean, enclosed or sealed cleaning zone. Within this cleaning zone is the wafer 1 held on a platen 2 by vacuum. The platen with wafer is kept at a controlled temperature of up to 100° C. Liquid CO₂, from a cylinder at room temperature and 850 psi, is first passed through a sintered in-line filter 4 to filter out very small particles from the liquid stream to render the carbon dioxide as pure as possible and reduce contaminants in the stream. The liquid CO₂ is then made to expand through a small aperture nozzle, preferably of from 0.05″ to 0.15″ in diameter. The rapid expansion of the liquid causes the temperature to drop resulting in the formation of solid CO₂ snow particles entrained in a gaseous CO₂ stream flowing at a rate of approximately 1-3 cubic feet per minute. The stream of solid and gaseous CO₂ is directed at the wafer surface at an angle of about 30° to about 60°, preferably at an angle of about 45°. The nozzle is preferably positioned at a distance of approximately 0.375″ to 0.5″ measured along the line of sight of the nozzle to the wafer surface. During the cleaning process, the platen 2 moves back and forth on track 9 in the y direction while the arm of the cleaning nozzle moves linearly on the track 10 in the x direction. This results in a rastered cleaning pattern on the wafer surface of which the step size and scan rate can be pre-set as desired. The humidity in the cleaning chamber is preferably maintained as low as possible, for example <−40° C. dew point. The low humidity is present to prevent the condensation and freezing of water on the wafer surface from the atmosphere during the cleaning process which would increase the force of adhesion between the contaminant particles and the wafer surface by forming crystalline bridges between them. The low humidity can be maintained by the flow of nitrogen or clean dry air.

As well, throughout the cleaning process, it is important that the electrostatic charge in the cleaning chamber be neutralized. This is done by the bipolar corona ionization bar 5. The system also has a polonium nozzle mounted directly behind the CO₂ nozzle for enhancing the charge neutralization of the wafer which is mounted on an electrically grounded platen. The electrostatic charge develops by triboelectrification due to the flow of CO₂ through the nozzle and across the wafer surface and is aided by the low humidity maintained in the cleaning chamber.

For particulate contaminants, the removal mechanism is primarily by momentum transfer of the CO₂ cryogenic particles to overcome the force of adhesion of the contaminant particles on the wafer surface. Once the particles are “loosened”, the drag force of the gaseous CO₂ removes it from the surface of the wafer. The cleaning mechanism for organic film contaminants is by the formation of a thin layer of liquid CO₂ at the interface of the organic contaminant and the surface due to the impact pressure of the cryogenic CO₂ on the wafer surface. The liquid CO₂ can then dissolve the organic contaminants and carry it away from the wafer surface.

The embodiments and examples of the present application are meant to be illustrative of the present invention and not limiting. Other embodiments which could be used in the present process would be readily apparent to a skilled person. It is intended that such embodiments are encompassed within the scope of the present invention.

### REFERENCES

[1]. International Technology Roadmap for Semiconductors 2001 Edition.
[2]. Handbook of Semiconductor Wafer Cleaning Technology Science, Technology and Applications, Edited by Werner Kern, Noyes Publications, 1993.
[3]. Particle Control for Semiconductor Manufacturing, Edited by R. P. Donovan, Marcel Dekker Inc., 1990.

1. A process for the removal of contaminants from a surface of a substrate requiring precision cleaning, comprising: (a) applying at least one fluid to the substrate surface, the fluid selected from the group consisting of a high vapor pressure liquid, a reactive gas, and vapor of a reactive liquid; and (b) cryogenically cleaning the surface of the substrate.

2. The process of claim 1 wherein (a) and (b) are carried out simultaneously.

3. The process of claim 1 wherein (a) and (b) are carried out sequentially.

4. The process of claim 1 wherein the at least one fluid is a high vapor pressure liquid selected from the group consisting of ethanol, acetone, ethanol-acetone mixtures, isopropyl alcohol, methanol, methyl formate, methyl iodide, ethyl bromide, acetonitrile, ethyl chloride, pyrrolidine, tetrahydrofuran and mixtures thereof.

5. The process of claim 1 wherein the at least one fluid is a vapor of a reactive liquid selected from the group of liquids consisting of ethanol, acetone, ethanol-acetone mixtures, isopropyl alcohol, methanol, methyl formate, methyl iodide, ethyl bromide, and mixtures thereof.

6. The process of claim 1 wherein the at least one fluid is a reactive gas selected from the group consisting of ozone, water vapor, hydrogen, nitrogen, nitrogen oxides, nitrogen triflouride, helium, argon, neon, sulfur trioxide, oxygen, fluorine, fluorocarbon gases and mixtures thereof.

7. The process of claim 1 wherein the at least one fluid is a reactive gas or vapor selected from the group consisting of isopropyl alcohol, ethanol-acetone mixtures, methanol, ozone, water vapor, nitrogen triflouride, sulfur trioxide, oxygen, fluorine and fluorocarbon gases, and mixtures thereof.

8. The process of claim 1 wherein the fluid remains in contact with the surface for up to 10 minutes prior to the cryogenic cleaning.

9. The process of claim 8 wherein the fluid remains in contact with the surface for less than 2 minutes prior to the cryogenic cleaning.

10. The process of claim 1 wherein the contaminants are less than 0.76 μm in size.

11. The process of claim 1 wherein the contaminants are less than 0.13 μm in size.

12. The process of claim 1 wherein the high vapor pressure liquid has a vapor pressure greater than about 5 kPa at 25° C., and a freezing point below about −50° C.

13. The process of claim 1 wherein the high vapor pressure liquid has a dipole moment of greater than about 1.5 D.

14. The process of claim 1 wherein the high vapor pressure liquid remains on the surface in a layer of at least 5 Δ for less than 10 minutes and preferably less than 2 minutes prior to the cryogenic cleaning.

15. The process of claim 4 further comprising the high vapor pressure liquid removing bulk water from the substrate surface.

16. The process of claim 1 wherein the substrate surface is a semiconductor, metal or dielectric film.

17. The process of claim 1 wherein the at least one fluid is a reactive gas or vapor which reacts with the contaminants on the surface to form a volatile gaseous byproduct; and further comprising: maintaining the reactive gas or vapor in contact with the surface for up to 20 minutes, and removing the gaseous byproduct prior to the cryogenic cleaning.

18. The process of claim 17 wherein the reactive gas or vapor is introduced in a chamber containing the substrate, under low pressure and/or at temperatures of up to 200° C.

19. The process of claim 18 wherein removing the byproduct comprises purging the chamber with nitrogen or clean dry air.

20. The process of claim 17 wherein the reactive gas or vapor is applied to the surface in the presence of a free radical initiator to generate reactive chemical byproducts from the reactive gas or vapour and the contaminants.

21. The process of claim 20 wherein the free radical initiator is selected from the group consisting of ultraviolet light, x-ray, laser, corona discharge, and plasma.
